(19) United States
(12) Patent Application Publication
(10) Pub. No.: US 2006/0106648 A1
(43) Pub. Date: May 18, 2006

(54) Intelligent patient context system for healthcare and other fields

(76) Inventors: Matthew Paul Esham, Pennsville, NJ (US); Jeffrey Granito, Norristown, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/262,637

(22) Filed: Oct. 31, 2005

Related U.S. Application Data
(60) Provisional application No. 60/623,608, filed on Oct. 29, 2004.

(51) Int. Cl. G06F 19/00; G06F 17/30

(52) U.S. Cl. 705/3; 707/6

(57) ABSTRACT

An intelligent patient context sharing system enables a user, interfacing with multiple, different sources each storing patient specific context information, to create probabilistic associations among the patient specific context information. The system includes a predictive identification processor and a communication processor. The predictive identification processor performs probabilistic matching on multiple different items of patient specific context information to identify a patient-context information item likely to be associated with a first patient-context information item. The communication processor communicates the identified patient-context information item to an executable application for use by the executable application in accessing information associated with a specific patient.

### CROSS-REFERENCE TO RELATED APPLICATIONS

The present application is a non-provisional application of provisional application having Ser. No. 60/623,608 filed by Matthew P. Esham, et al. on Oct. 29, 2004.

### FIELD OF THE INVENTION

The present invention generally relates to computer information systems. More particularly, the present invention relates to an intelligent patient context system for healthcare and other fields.

### BACKGROUND OF THE INVENTION

Computer information systems (“systems”) include computers that communicate with each other over a network, such as the Internet, and computers that manage information. For example, a healthcare enterprise uses the systems to manage healthcare information for patients.

Healthcare enterprises range from a single office in a single building, to multiple office in a single building, to multiple buildings in a local campus, to multiple buildings or campuses in a geographic area. Healthcare enterprises expand their geographic area of service by expanding their present healthcare enterprise or by purchasing other existing healthcare enterprises.

Other existing healthcare enterprises may have one or more different or separate computer systems that manage healthcare information for their patients. An expanded or combined healthcare enterprise may result in multiple different or separate computer systems that manage respective healthcare information for their respective patients.

An example of healthcare information is patient registration information, which includes patient identification or medical record numbers. Therefore, an expanded or combined healthcare enterprise may result in result in a single patient having multiple patient identifications or medical record numbers, which can be confusing, difficult to track, lead to errors or misidentification, etc. For example, misidentification may be caused by manual entry errors, or multiple registration systems across a healthcare enterprise using the same identification for different patients.

An expanded or combined healthcare enterprise may also include other redundant healthcare information or services, such as, for example, image archives of patient test results for respective imaging technologies, which increases overhead cost.

Accordingly, there is a need for an intelligent patient context system for healthcare and other fields that overcomes these and other disadvantages.

### SUMMARY OF THE INVENTION

A system enables a user to associate multiple, different patient-specific context information items stored in multiple computer sources. The system includes a predictive identification processor and a communication processor. The predictive identification processor performs probabilistic matching on multiple different items of patient specific context information to identify a patient-context information item likely to be associated with a first patient-context information item. The communication processor communicates the identified patient-context information item to an executable application for use by the executable application in accessing information associated with a specific patient.

### BRIEF DESCRIPTION OF THE DRAWINGS

FIG. 1 illustrates an intelligent patient context system, in accordance with invention principles.

FIG. 2 illustrates a collaboration diagram for the system, as shown in FIG. 1, in accordance with invention principles.

FIG. 3 illustrates a transaction diagram incorporating a method for the system, as shown in FIG. 1, in accordance with invention principles.

### DETAILED DESCRIPTION OF THE PREFERRED EMBODIMENTS

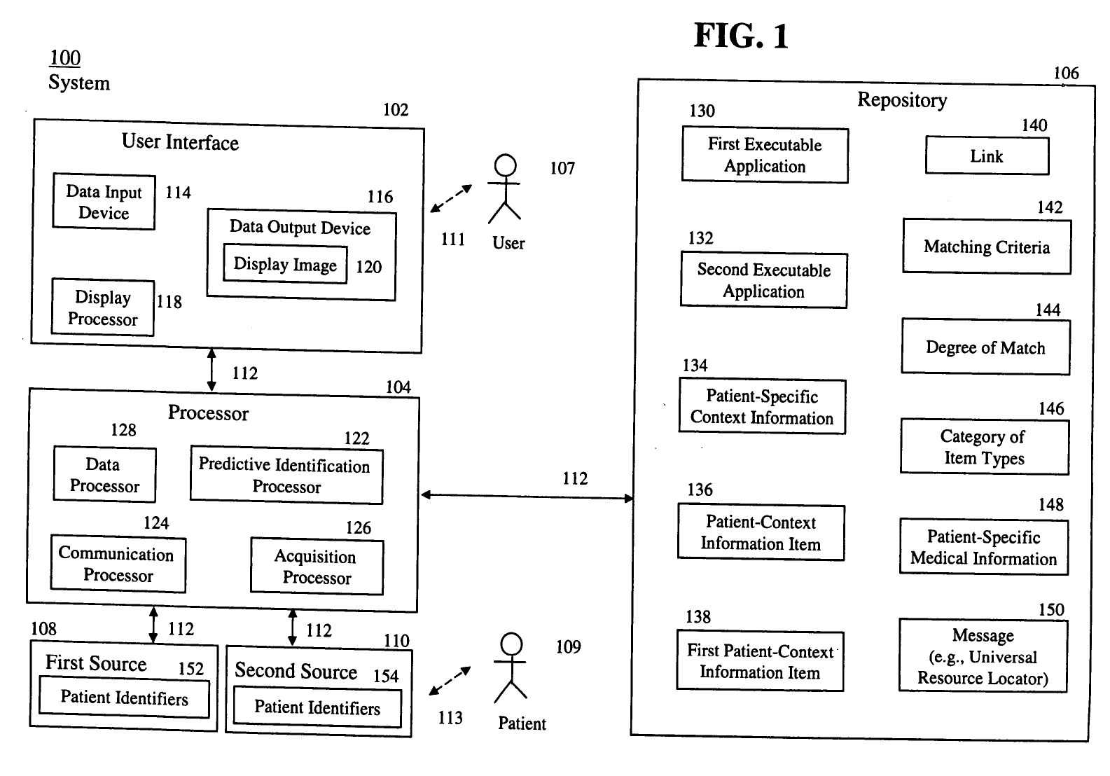

FIG. 1 illustrates an intelligent patient context sharing (IPCS) system 100. The system 100 includes a user interface 102, a processor 104 (otherwise called “a patient sharing context engine”), and a repository 106 (otherwise called “a content store” or “a database”). A first source 108, a second source 110, and a user 107 interfaces and/or interacts with the system 100. A patient 109 interfaces and/or interacts with the first source 108 and/or the second source 110.

A communication path 112 interconnects elements of the system 100, and/or interconnects the system with the first source 108 and/or the second source 110. The dotted line near reference number 111 represents interaction between the user 107 and the user interface 102. The dotted line near reference number 113 represents interaction between the patient 109 and the first source 108 and/or the second source 110.

The user interface 102 further provides a data input device 114, a data output device 116, and a display processor 118. The data output device 116 further provides one or more display images 120.

The processor 104 further includes a predictive identification processor 122, a communication processor 124, an acquisition processor 126, and a data processor 128.

The repository 106 further includes a first executable application 130, a second executable application 132, patient-specific context information 134, a patient-specific context information item 136, a first patient-context information item 138, a link 140, matching criteria 142, a degree of match 144, a category of item types 146, patient-specific medical information 148, and a message (e.g., a universal resource locator (URL)) 150.

The system 100 may be employed by any type of enterprise, organization, or department, such as, for example, providers of healthcare products and/or services responsible for servicing the health and/or welfare of people in its care. For example, the system 100 represents a hospital information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 and/or elements contained therein also may be implemented in a centralized or decentralized configuration. The system 100 may be implemented as a client-server, web-based, or stand-alone configuration. In the case of the client-server or web-based configurations, one or more of the executable applications 130 and 132 may be accessed remotely over a communication network.

The communication path 112 (otherwise called network, bus, link, connection, channel, etc.) represents any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface 102 permits bi-directional exchange of data between the system 100 and the user 107 of the system 100 or another electronic device, such as a computer or an application.

The data input device 114 typically provides data to a processor in response to receiving input data either manually from a user or automatically from an electronic device, such as a computer. For manual input, the data input device is a keyboard and a mouse, but also may be a touch screen, or a microphone with a voice recognition application, for example.

The data output device 116 typically provides data from a processor for use by a user or an electronic device or application. For output to a user, the data output device 116 is a display, such as, a computer monitor (screen), that generates one or more display images in response to receiving the display signals from the display processor 118, but also may be a speaker or a printer, for example.

The display processor 118 or generator includes electronic circuitry or software or a combination of both for generating display images or portions thereof. The data output device 116, implemented as a display, is coupled to the display processor 118 and displays the generated display images. The display images permit user interaction with the processor 104 or other device. The display processor 118 may be implemented in the user interface 102 and/or the processor 104.

The system 100, elements, and/or processes contained therein may be implemented in hardware, software, or a combination of both, and may include one or more processors, such as processor 104. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

The repository 106 represents any type of storage device, such as computer memory devices or other tangible storage medium. The repository 106 represents one or more memory devices, located at one or more locations, and implemented as one or more technologies, depending on the particular implementation of the system 100.

An executable application, such as the first executable application 130 or the second executable application 132, comprises machine code or machine readable instruction for implementing predetermined functions including, for example, those of an operating system, a software application program, a healthcare information system, or other information processing system, for example, in response user command or input. An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters. A calling procedure is a procedure for enabling execution of another procedure in response to a received command or instruction. An object comprises a grouping of data and/or executable instructions or an executable procedure.

The system 100 supports concurrent operation of multiple, maybe different executable applications 130, 132. For example, the executable applications 130, 132 may be running patient registration and tracking programs.

The predictive identification processor 122 performs probabilistic matching on multiple, different items of patient specific context information 134 to identify a patient context information item 136 likely to be associated with a first patient context information item 138.

The communication processor 124 communicates the identified patient context information item 136, or one of the multiple, different items of patient specific context information 134 identified as being associated with the first patient context information item 138, to an executable application 130 for use by the executable application 130 in accessing information associated with a specific patient 109.

The acquisition processor 126 acquires multiple, different patient identifiers 152, 154 associated with a single patient from multiple sources 108, 110. The multiple, different patient identifiers 152, 154 are processed by the predictive identification processor 122 to identify a particular patient identifier as the context information item 136 for communication by the communication processor 124 to the executable application 130. The acquisition processor 126 is configurable by a user 107 to acquire multiple, different patient identifiers 152, 154 from user selected multiple sources 108, 110.

The communication processor 124 communicates the identified patient-context information item 136 to the executable application 130 in a message 150. The message 150 comprises, for example, a universal resource locator (URL). The URL is for use in acquiring patient-specific medical information 148. The URL is also for use in conveying information supporting automatic logon of a user 107 to the executable application 130.

The data processor 128 performs other specific or general purpose processing.

The identified patient-context information item 136 includes, for example, one or more of the following: a patient identifier, a patient medical record number, a user identification 107, a password, a session identifier, a medical image identifier, patient contact information, patient address information, patient insurance information, patient treatment information, patient treatment order information, and patient healthcare provider identification information.

The user interface 102 provides data, representing one or more display images 120, permitting a user 107 to perform one or more of the following actions. The user may create a link 140 (e.g., a hyperlink) enabling the communication processor 124 to communicate the identified patient-context information item 136 to an executable application 130 for incorporation in a previously non-related data record. The user may determine matching criteria 142 for use in identifying the patient-context information item 136 likely to be associated with the first patient-context information item 138. The user may determine partial matching criteria 142 and/or determine a degree of match 144 to be reached to identify the patient-context information item 136 that is likely to be associated with the first patient-context information item 138.

The system 100 advantageously enables sharing of patient-context information items 136 across the multiple, maybe different sources, to create probabilistic matches when patient information may not match. The patient-context information items 136 may be shared in the data fields of a message 150 including a URL, for example. The system 100 advantageously provides seamless and concurrent operation of multiple, maybe different executable applications 130, 132.

The system 100 employs a grading system ranking how closely the patient-context information items 136 match across the multiple, different sources. The system 100 allows the user to configure a level of “sameness” (otherwise called a probabilistic match) required for the system 100 to consider information a match. The system 100 advantageously resides beneath a context sharing mechanism so that the system 100 may be used with an interface standard, such as, for example, Clinical Context Object Working Group (CCOW) in the Health Level 7 (HL7) standard.

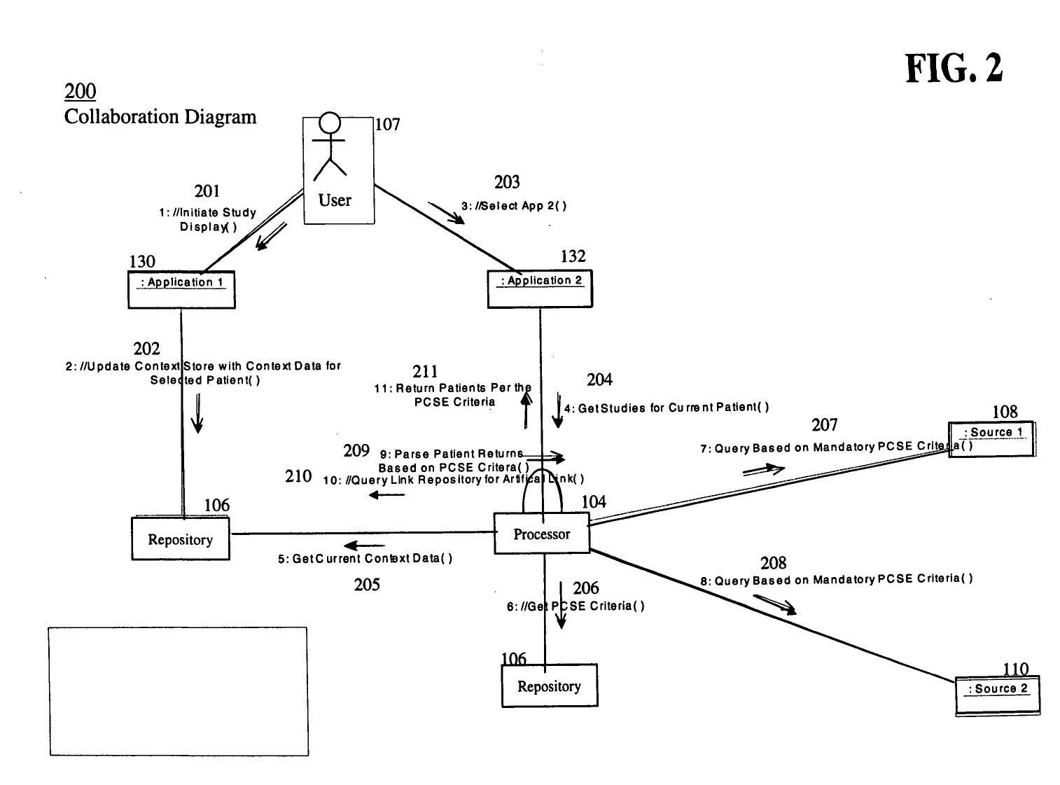

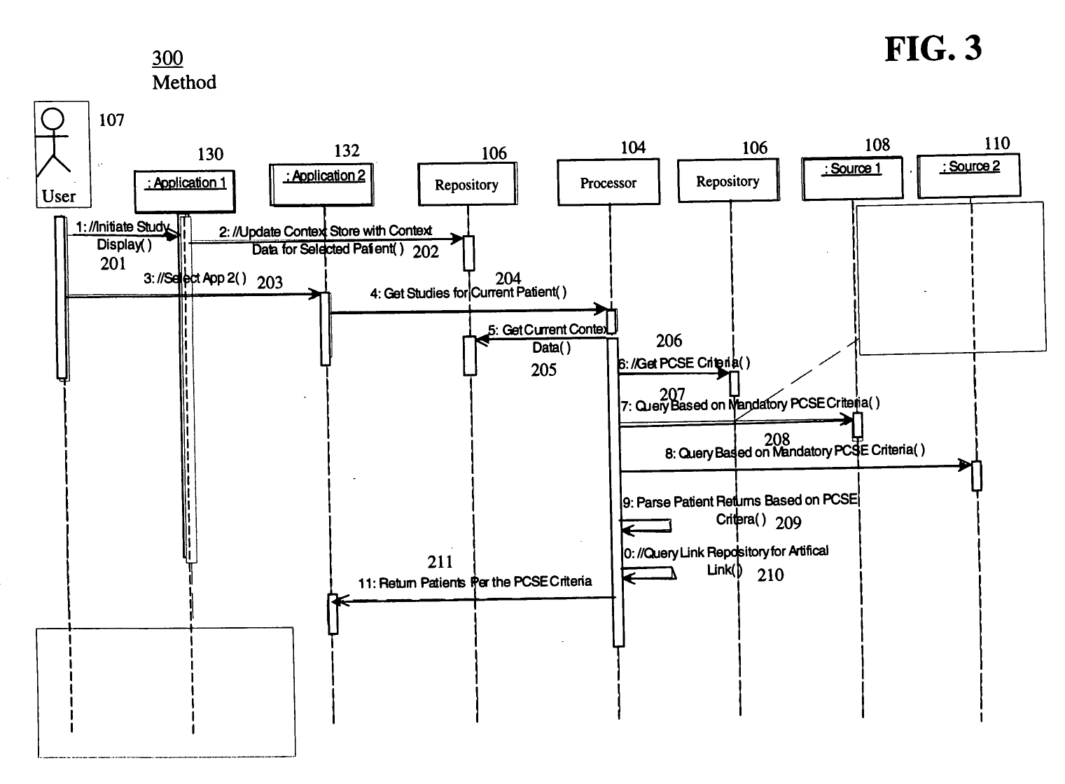

FIGS. 2 and 3 are described together. FIG. 2 illustrates a collaboration diagram 200 for the system 100, as shown in FIG. 1. FIG. 3 illustrates a transaction diagram incorporating a method 300 for the system 100, as shown in FIG. 1. The transactions 201-211 (otherwise called method steps, collaborations, or interactions) shown in FIGS. 2 and 3 are the same in both figures.

At step 201, the system 100, in response to an indication from the user 107, to initiate execution of (e.g., initiate a study or examination) the first executable application 130. For example, the user 107 may enter a command or click on a link or an icon, representing the first executable application 130, via the user interface 102.

At step 202, the system 100 displays the first executable application 130, and updates the repository 106 with one or more of the following patient-specific context information 134, as shown in Table 1, for example: medical record number, patient ID number, other patient's IDs, ethnic group, social security or government ID number, date of birth, entity ID, address, patient first name, patient's middle initial, patient's last name, gender, and issuer of patient ID.

At step 203, the system 100, in response to an indication from the user 107, to initiate execution of (e.g., initiate a study or examination) the second executable application 132. For example, the user 107 may enter a command or click on a link or an icon, representing the second executable application 132, via the user interface 102. The expected outcome is for second executable application 132 to display a list of exams for the patient selected via the first executable application 130.

At step 204, the second executable application 132 requests a study list for the current patient from the processor 104 (otherwise called a data collector).

At step 205, the processor 104 requests and receives the current context information for the current patient from the repository 106, which was stored in the repository 106 in step 202.

At step 206, the processor 104 requests the matching criteria 142 (otherwise called the patient context sharing criteria or values) from the repository 106, which identifies which matching criteria are mandatory and which values are subjective, for example.

Depending on the particular installation, the system 100 may be configured so any data field, having a corresponding field description, may be selected as a Mandatory Matching Criteria (MMC) or a Subjective Matching Criteria (SMC), as shown in Table 1 below. For the MMC, the criteria must match, or the system 100 will not consider the data to be from the same patient. For the SMC, the system 100 uses a grading mechanism (e.g., probabilistic matching), for example, based on the selected information, including a positive or a negative value (e.g., from +10 to −10) relative to the match criteria. For example, the system 100 allows a match value of the match criteria for the MMC, and configures a non-match value of the match criteria with a value from +10 to −10 for the SMC. Various other grading mechanisms may be employed.

Patient context information is considered matched if the MMC are met and/or the SMC are met, depending on the configuration of the system 100. The user 107 may configure the system 100 to have all or no MMC, and/or all or no SMC. For example, the level of a match for the SMC may be set from 1 to 99%. If less than 100% match occurs, the user 107 is presented with a dialogue (e.g., a visual communication on the display image 120) containing detailed information about the comparison.

In Table 1, the user 107 may select any particular field as a MMC and/or a SMC, such as by clicking in the box corresponding to the particular field. If the field is selected as an SMC, the user 107 selects the value of the match or mismatch.

TABLE 1

| | | | | SMC Match Value | SMC Non-Match |
|---|---|---|---|---|---|
| Field | Field Definition | MMC | SMC | (Default) | Value (Default) |
| Medical Record Number | An entity or visit based number. | | | 3 | −3 |
| | Usually is not unique. | | | | |
| Patient ID Number | An enterprise based number. | | | 10 | −10 |
| | Should be a unique identifier. | | | | |
| Other Patient's IDs | A secondary patient ID | | | 10 | −10 |
| Patient's Mother's | The patient's mother's | | | 3 | −5 |
| Birth Name | birth name. | | | | |
| Ethnic Group | Ethnic Group | | | 3 | −5 |
| Social Security or | A unique government personal | | | 10 | −10 |
| Government ID Number | identifier issued by the user's | | | | |
| | home federal government. | | | | |
| | Is a unique identifier | | | | |
| Date of Birth | The date the patient was born. | | | 3 | −3 |
| Entity ID | The entity where the study | | | 2 | −2 |
| | was performed | | | | |
| Address | The address of the patient. | | | 3 | −1 |
| Patient First Name | The patient's first name. | | | 2 | −3 |
| Patient's Middle Initial | The patient's middle initial. | | | 1 | −3 |
| Patient's Last Name | The patient's last name. | | | 3 | −5 |
| Gender | The patient's gender. | | | 1 | −10 |
| Issuer of Patient ID | The Issuer of the patient's ID. | | | 1 | −1 |

At step 207, the processor 104 creates and issues a query of the mandatory values to the first source 108 using the acquisition processor 126.

At step 208, the processor 104 creates and issues a query of the mandatory values to the second source 110 using the acquisition processor 126.

At step 209, the processor 104 processes (i.e., program, decisions, parsing, etc.) the patient context information, according to the subjective criteria, as describe in Table 1, to determine whether to display a match on the display image 120 for the user 107. If the patient context information is within the range permitted by the subjective criteria, then the processor 104 displays the matched patient context information and/or an indication of a match on the display image 120; otherwise, the patient context information is not displayed and an indication that there is no match may or may not displayed. Depending on the particular patient context information, the range permitted by the subjective criteria relates to how close a match is needed. This correspondence may be predetermined by the system 100. Various types of grading mechanisms and/or correspondence to the grading mechanisms may be employed in the system 100.

At step 210, the processor 104 queries a link database in the repository 106 to determine if any data is linked, via an artificial link, to the current patient.

At step 211, the processor 104 returns to the second executable application patient information corresponding to the matching criteria for the current patient, and displays the matching patient information on the display image 120 for the user 107.

The system 100 advantageously enables a user 107 to create an artificial link between at least two pieces of patient information retrieved from at least two sources 108, 110, which may not appear to match, using messaging, such as URLs. For example, a user 107 may want to share context between a mother's prenatal fetal exam, including the mother's name, patient identification, and other identifiers, and the mother's post birth exam, which may have occurred at different healthcare facilities managed by the same or different computer information systems.

In an alternative embodiment, the system 100 utilizes an Integrating the Healthcare Enterprise (IHE) Patient Identifier Cross-referencing (PIX) protocol. This protocol enables a user 107 to designate the sources 108 and 110 as domains, and create a domain manager (e.g., in the processor 104). The domain manager is configured to know that patient identification 152 (e.g., 1234) in the first source 108 is patient identification 154 (e.g., 5678) in the second source 110, and manage patient context sharing across the sources.

The system 100 supports modality (e.g., MR, CT, Ultrasound, X-ray, etc.) patient-specific context sharing to allow the sharing of patient context across various imaging platforms in a mixed information technology environment. The system 100 is integrated with a work-list study browser at a modality and a modality reading workstation. The work-list study browser integrates context sharing into the user interface 102. Alternatively, the system 100 may use Digital Imaging and Communications in Medicine (DICOM) (i.e., a standard for distributing and viewing any kind of medical image regardless of the origin) specific tags to share context.

The system 100 advantageously provides dynamic patient data link creation and integration of multiple data sources across a healthcare enterprise allowing for users 107 to efficiently manage existing patient information.

Hence, while the present invention has been described with reference to various illustrative examples thereof, it is not intended that the present invention be limited to these specific examples. Those skilled in the art will recognize that variations, modifications, and combinations of the disclosed subject matter can be made, without departing from the spirit and scope of the present invention, as set forth in the appended claims.

What is claimed is:

1. A system supporting concurrent operation of a plurality of different executable applications, comprising:
a predictive identification processor for performing probabilistic matching on a plurality of different items of patient specific context information to identify a patient context information item likely to be associated with a first patient context information item; and
a communication processor for communicating said identified patient-context information item to an executable application for use by said executable application in accessing information associated with a specific patient.

2. A system according to claim 1, wherein
said communication processor communicates said identified patient context information item to said executable application in a message.

3. A system according to claim 2, wherein
said message comprises a URL.

4. A system according to claim 3, wherein
said URL is for use in acquiring patient specific medical information.

5. A system according to claim 3, wherein
said URL is for use in conveying information supporting automatic logon of a user to said executable application.

6. A system according to claim 1, wherein
said identified patient context information item comprises at least one of, (a) a patient identifier and (b) a patient medical record number.

7. A system according to claim 1, wherein
said identified patient context information item comprises at least one of, (a) a user ID, (b) a password, and (c) a session identifier.

8. A system according to claim 1, wherein
said identified patient context information item comprises at least one of, (a) medical image identifier, (b) patient contact information, (c) patient address information, (d) patient insurance information, (e) patient treatment information, (e) patient treatment order information and (f) patient healthcare provider identification information.

9. A system according to claim 1, including
an acquisition processor for acquiring a plurality of different patient identifiers associated with a single patient from multiple sources, said plurality of different patient identifiers being processed by said predictive identification processor to identify a particular patient identifier as said context information item for communication by said communication processor to said executable application.

10. A system according to claim 1, wherein
said acquisition processor is configurable by a user to acquire a plurality of different patient identifiers from user selected multiple sources.

11. A system according to claim 1, including
a user interface providing data representing at least one display image enabling a user to create a link enabling said communication processor to communicate said identified patient context information item to an executable application for incorporation in a previously non-related data record.

12. A system according to claim 1, including
a user interface providing data representing at least one display image enabling a user to determine matching criteria for use in identifying said patient-context information item likely to be associated with said first patient-context information item.

13. A system according to claim 12, wherein
said at least one display image enables a user to at least one of, (a) determine partial matching criteria and (b) determine a degree of match to be reached, to identify said patient context information item likely to be associated with said first patient context information item.

14. A system supporting concurrent operation of a plurality of different executable applications, comprising:
a predictive identification processor for performing probabilistic matching on a plurality of different items of patient specific context information to identify a patient context information item most likely to be associated with a first patient context information item; and
a communication processor for communicating one of said plurality of different items of patient specific context information identified as being associated with said first patient context information item, to an executable application for use by said executable application in accessing information associated with a specific patient.

15. A method supporting concurrent operation of a plurality of different executable applications, comprising the activities of:
performing probabilistic matching on a plurality of different items of patient specific context information to identify a patient context information item most likely to be associated with a first patient context information item; and
communicating said identified patient-context information item to an executable application for use by said executable application in accessing information associated with a specific patient.

16. A method supporting concurrent operation of a plurality of different executable applications, comprising the activities of:
performing probabilistic matching on a plurality of different items of patient specific context information to identify a patient context information item most likely to be associated with a first patient context information item; and
communicating one of said plurality of different items of patient specific context information identified as being associated with said first patient context information item, to an executable application for use by said executable application in accessing information associated with a specific patient.
